(19) United States
(12) Patent Application Publication
(10) Pub. No.: US 2016/0377486 A1
(43) Pub. Date: Dec. 29, 2016

(54) CONTACT-PROBE TYPE TEMPERATURE DETECTOR, SEMICONDUCTOR DEVICE EVALUATION APPARATUS AND SEMICONDUCTOR DEVICE EVALUATING METHOD

(71) Applicant: Mitsubishi Electric Corporation, Tokyo (JP)

(72) Inventors: Kinya YAMASHITA, Tokyo (JP); Takaya NOGUCHI, Tokyo (JP); Akira OKADA, Tokyo (JP); Hajime AKIYAMA, Tokyo (JP); Masaki UENO, Tokyo (JP)

(73) Assignee: Mitsubishi Electric Corporation, Tokyo (JP)

(21) Appl. No.: 15/064,054

(22) Filed: Mar. 8, 2016

(30) Foreign Application Priority Data
Jun. 23, 2015 (JP) 2015-125432

(51) Int. Cl. G01K 1/14; H01C 7/00; G01K 7/02

(52) U.S. Cl. CPC G01K 1/143; G01K 7/02; H01C 7/008

(57) ABSTRACT

A temperature detecting probe as a contact-probe type temperature detector includes a plunger portion contactable with a semiconductor device as an object to be measured, a spring member placed on a base end portion of the plunger portion, a barrel portion pressing the plunger portion the semiconductor device side with the spring member interposed therebetween, and a thermocouple as a temperature measuring portion detecting a temperature of the semiconductor device.

### BACKGROUND OF THE INVENTION

Field of the Invention

The present invention relates to techniques for detecting the temperatures of semiconductor devices, in evaluating electric characteristics of the semiconductor devices.

Description of the Background Art

In evaluating electric characteristics of semiconductor devices as objects to be measured, it is important to detect the temperatures of the semiconductor devices with higher accuracy. Particularly, in evaluating their temperature characteristics, if the detection of the temperature during evaluations is unstable, the temperature characteristics are made to include errors. Further, in evaluating their electric characteristics, the temperatures of the semiconductor devices may change due to larger electric currents and higher voltages which are applied thereto. In this case, similarly, it is important to detect temperature changes in the semiconductor devices, as well as their electric characteristics.

Under such circumstances, there have been known non-contact type methods, as methods for detecting the temperatures of semiconductor devices. For example, as such non-contact type methods, there have been temperature detections using optical-type radiation thermometers. However, in cases where the semiconductor devices have mirror surfaces at their surfaces, it is hard to perform temperature detection therewith. Even if it is possible to perform detections therewith, the detected temperature can easily change depending on the emissivity setting. Therefore, the temperatures of the semiconductor devices cannot be accurately determined therewith.

As methods for detecting the temperatures of objects to be measured, Japanese Patent Application Laid-Open No. 2010-26715 and Japanese Patent Application Laid-Open No. 2013-254873 disclose the following methods, for example. Japanese Patent Application Laid-Open No. 2010-26715 discloses installing a temperature sensor at a resin installation table for installing objects to be measured thereon, and controlling the temperature of the inside of a bath based on the temperature measured by the temperature sensor. Further, Japanese Patent Application Laid-Open No. 2013-254873 discloses providing a thermistor equipped with leads within a power module and measuring the temperatures of semiconductor elements through the thermistor.

Further, as other methods for detecting the temperatures of objects to be measured, for example, Japanese Patent Application Laid-Open No. 61-187245 (1986), Japanese Patent Application Laid-Open No. 2007-227444, and Japanese Patent Application Laid-Open No. 2011-215007 disclose measurement systems of cantilever types.

### SUMMARY OF THE INVENTION

However, the temperature sensor described in Japanese Patent Application Laid-Open No. 2010-26715 is installed at the resin installation table and, also, is spaced apart from the object to be measured. This makes it impossible to detect the temperature of the object to be measured itself with higher accuracy. Further, it has been impossible to employ this temperature sensor in conventional evaluation apparatuses.

Further, the thermistor described in Japanese Patent Application Laid-Open No. 2013-254873 is adapted to measure the temperatures of semiconductor elements with an air layer interposed therebetween. This makes it impossible to detect the temperatures of the semiconductor elements themselves with higher accuracy.

Further, the measurement systems described in Japanese Patent Application Laid-Open No. 61-187245 (1986), Japanese Patent Application Laid-Open No. 2007-227444, and Japanese Patent Application Laid-Open No. 2011-215007 necessitate inclining probes due to the principles of the cantilever types. Further, in measuring electric characteristics of high-voltage devices, it is impossible to arbitrarily set the distance between the object to be measured and the inclined portions of the probes, which induces the problem of difficulty in suppressing aerial discharge.

It is an object of the present invention to provide techniques capable of suppressing aerial discharge in evaluating electric characteristics of semiconductor devices and capable of detecting the temperatures of semiconductor devices with higher accuracy.

A contact-probe type temperature detector according to the present invention includes a plunger portion contactable with an object to be measured, a spring member placed on a base end portion of the plunger portion, a barrel portion pressing the plunger portion the object to be measured side with the spring member interposed therebetween, and a temperature measuring portion detecting a temperature of the object to be measured.

The plunger portion is pressed the object to be measured side by the barrel portion with the spring member interposed therebetween, which ensures the contact between the plunger portion and the object to be measured, and the temperature of the object to be measured is detected by the temperature measuring portion. Accordingly, in evaluating electric characteristics of a semiconductor device, it is possible to accurately detect the temperature of the semiconductor device.

Further, since the contact-probe type temperature detector is adapted such that the plunger portion is pressed the object to be measured side through the spring member, it is possible to provide a larger distance from the object to be measured to the portion to which the contact-probe type temperature detector is mounted, which can suppress aerial discharge, in comparison with cases of cantilever types.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a semiconductor-device evaluation apparatus according to a preferred embodiment;

FIGS. 2A, 2B and 2C are operation explanatory views of a spring-type evaluation probe;

FIGS. 3A and 3B are schematic views for explaining suppression of aerial discharge;

FIG. 4 is a schematic view of a temperature detecting probe;

FIG. 5 is a schematic cross-sectional view of a portion of a plunger portion:

FIG. 6 is a schematic cross-sectional view of a portion of a plunger portion in a temperature detecting probe according to a modification example 1 of the preferred embodiment;

FIG. 7 is a schematic cross-sectional view of a portion of a plunger portion in a temperature detecting probe according to a modification example 2 of the preferred embodiment;

FIG. 8 is a schematic perspective view of a temperature-measuring-portion installation jig;

FIG. 9 is a schematic cross-sectional view of a portion of a plunger portion in a temperature detecting probe according to a modification example 3 of the preferred embodiment;

FIG. 10 is a schematic view illustrating an example of the placement and structure of the temperature detecting probe;

FIG. 11 is a schematic view illustrating another example of the placement and structure of the temperature detecting probe;

FIG. 12 is a schematic view illustrating yet another example of the placement and structure of the temperature detecting probe; and

FIG. 13 is a schematic view illustrating yet another example of the placement and structure of the temperature detecting probe.

### DESCRIPTION OF THE PREFERRED EMBODIMENTS

### Preferred Embodiment

Hereinafter, a preferred embodiment of the present invention will be described, with reference to the drawings. FIG. 1 is a schematic view of a semiconductor-device evaluation apparatus 1 according to the preferred embodiment.

In the present preferred embodiment, there will be described an example where a temperature detecting probe 7 of a spring type is placed on an insulation plate 16, in order to detect the temperature of the surface of a semiconductor device 5 as an object to be measured, before and during evaluations of electric characteristics of the semiconductor device 5. Further, in the present preferred embodiment, as an example, there will be described the semiconductor device 5 having a longitudinal-type structure adapted to flow a larger electric current in the longitudinal direction of the semiconductor device 5, namely in the out-of-plane direction, but the semiconductor device is not limited thereto and can be also a semiconductor device having a lateral-type structure adapted to perform inputting and outputting through a single surface of the semiconductor device.

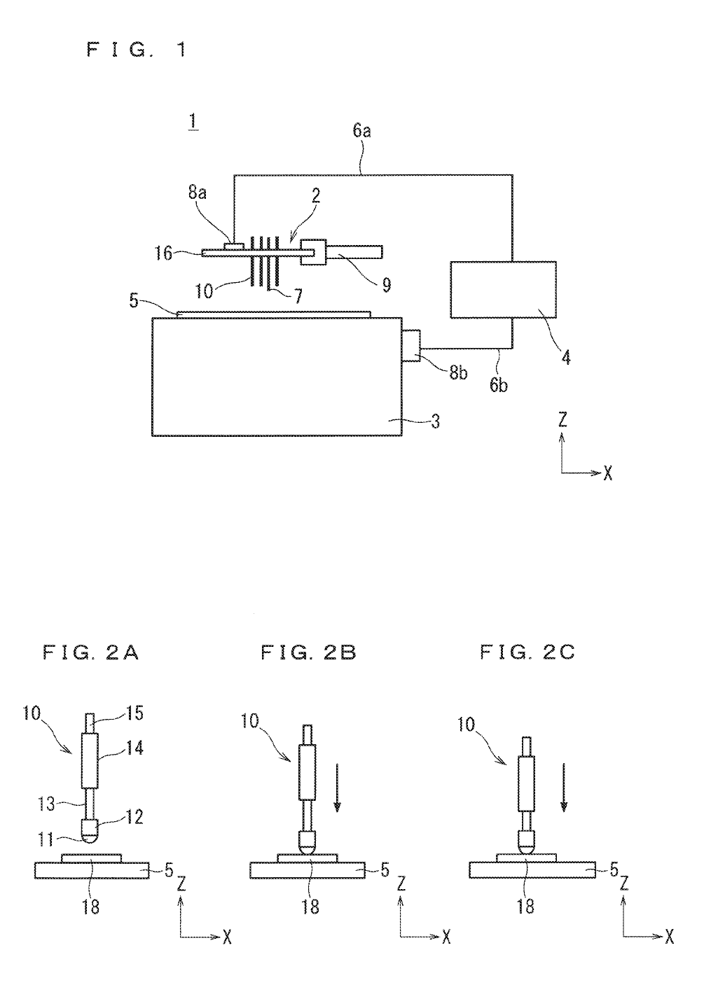

The evaluation apparatus 1 includes a chuck stage 3 (stage), spring-type evaluation probes 10, the temperature-detecting probe 7 (the contact-probe type temperature detector), and a control portion 4. In evaluating the semiconductor device 5 having the longitudinal-type structure, one electrode for connecting it to the outside is formed by the evaluation probes 10 which come into contact with connection pads 18 (see FIGS. 2A to 2C) which are provided on the upper surface of the semiconductor device 5. The other electrode is formed by the surface of the chuck stage 3 which comes in contact with the lower surface of the semiconductor device 5, namely the installation surface of the semiconductor device 5. The evaluation probes 10 are fixed to the insulation plate 16 and are electrically connected to the control portion 4 through a signal line 6a connected to the insulation plate 16 through a connection portion 8a. The chuck stage 3 is electrically connected, at its surface, to the control portion 4, through a signal line 6b connected thereto through a connection portion 8b provided on a side surface of the chuck stage 3.

The control portion 4 controls respective portions of the evaluation apparatus 1. The control portion 4 is constituted by a processing circuit, wherein the processing circuit may be constituted either by dedicated hardware or by a CPU for executing programs stored in memories (Central Processing Unit, which is also referred to as a central processing device, a processing device, an operating device, a microprocessor, a microcomputer, a processor, or a DSP).

Further, two or more evaluation probes 10 are placed, on the assumption that a larger electric current (for example, 5 A or more) should be applied to the semiconductor device 5. In this case, it is desirable to provide the respective connection portions 8a and 8b at such positions that the distance from the connection portion 8a as the position for connecting the signal line 6a and the insulation plate 16 to each other to the connection portion 8b provided on the side surface of the chuck stage 3 is made substantially constant, no matter which evaluation probe 10 is interposed therebetween. Namely, it is desirable that the connection portion 8a and the connection portion 8b are at respective positions facing each other, with the evaluation probes 10 interposed therebetween. Further, each evaluation probe 10 and the connection portion 8a are connected to each other, through a wiring formed from a metal plate and the like, which is provided on the insulation plate 16, for example, although not illustrated.

The evaluation probes 10, the temperature-detecting probe 7, the insulation plate 16, the connection portion 8a, and the wirings (not illustrated) for connecting the respective probes 7 and 10 to the connection portion 8a constitute a probe base body 2, which is held by a moving arm 9 and is made movable in arbitrary directions. In this case, the probe base body 2 is structured to be held by the single moving arm 9, but is not limited thereto and can be also held more stably by two or more moving arms. Also, instead of moving the probe base body 2, it is also possible to move the semiconductor device 5, namely the chuck stage 3.

The chuck stage 3 is a pedestal for fixing the semiconductor device 5 by being brought into contact with the installation surface of the semiconductor device 5, and the chuck stage 3 has a vacuum suction function, for example, as fixing means. Further, the means for fixing the semiconductor device 5 is not limited to vacuum suction and can be also electrostatic suction, and the like, for example.

Next, the evaluation probes 10 will be described. FIGS. 2A to 2C are operation explanatory views of the spring-type evaluation probes 10, wherein FIG. 2A illustrates an initial state, FIG. 2B illustrates a contact state, and FIG. 2C illustrates a pressed state.

The evaluation probes 10 include a barrel portion 14 which functions as a pedestal and is fixed to the insulation plate 16, a contact portion 11 which is brought into mechanical and electrical contact with the connection pad 18 provided on the surface of the semiconductor device 5, a plunger portion 12 having a pushing portion 13 which can slide during contact through a spring member such as a spring incorporated inside the barrel portion 14, and a terminal portion 15 which is electrically communicated with the plunger portion 12 and forms an output end for outputting to the outside.

The evaluation probes 10 are formed from a metal material having electrical conductivity, such as copper, tungsten, rhenium tungsten, for example, but the material thereof is not limited thereto and, particularly, the contact portion 11 can be also formed from a material constituted by the aforementioned metal material coated with another material such as gold, palladium, tantalum, platinum and the like, in view of improvement of the electrical conductivity, improvement of durability, and the like.

If each evaluation probe 10 descends toward the connection pad 18 provided on the semiconductor device 5, downwardly (in the −Z direction), from the initial state illustrated in FIG. 2A, the contact portion 11 comes into contact with the connection pad 18, at first, as illustrated in FIG. 2B. Thereafter, if each evaluation probe 10 further descends, as illustrated in FIG. 2C, the pushing portion 13 is partially pushed into the barrel portion 14 with the spring member interposed therebetween, which ensures the contact thereof with the connection pad 18 on the semiconductor device 5.

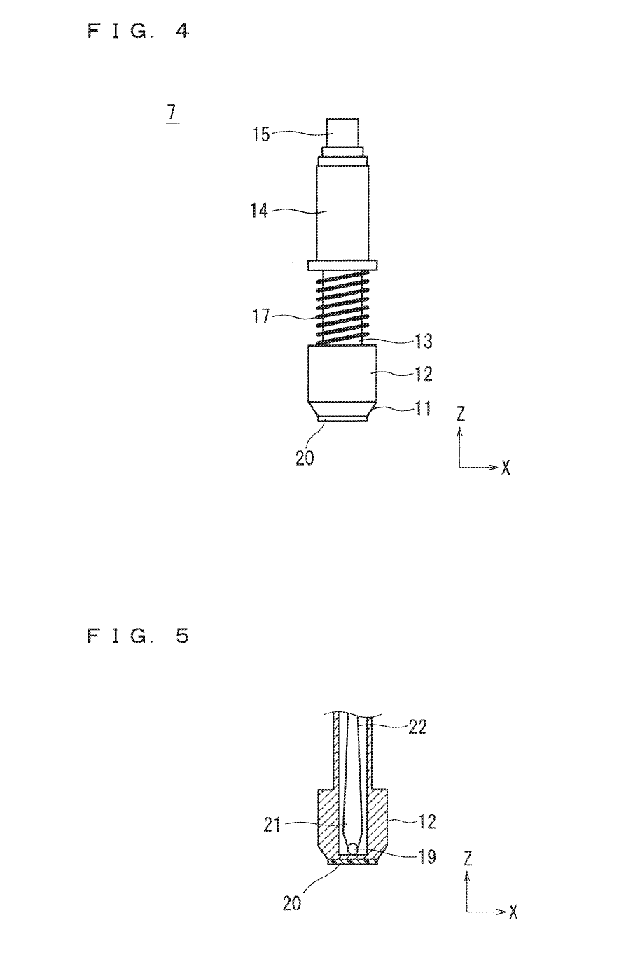

In this case, the evaluation probes 10 have been described as having a structure interiorly provided with the spring member with slidability in the Z-axis direction. However, the evaluation probes 10 are not limited thereto and also may have a structure provided exteriorly with a spring member, as the spring-type temperature detecting probe 7 illustrated in FIG. 4, which will be described later.

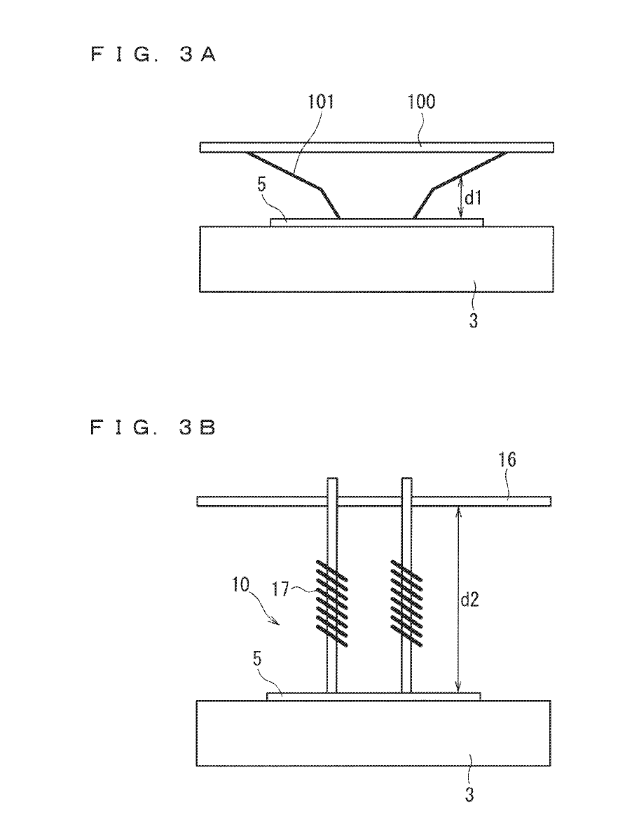

Next, there will be described merits provided by the use of the evaluation probes 10 and the temperature detecting probe 7 which are of the spring type, in comparison with prior techniques. FIGS. 3A and 3b are schematic views for explaining suppression of aerial discharge, wherein FIG. 3A illustrates an example of a case of a cantilever type as a prior technique. FIG. 3B illustrates an example of a case of a spring type, exemplifying evaluation probes 10.

As illustrated in FIG. 3A, in the case of the cantilever type, due to the principle of the cantilever type, it is necessary to incline probes 101 with respect to an insulation plate 100, and, in evaluating electric characteristics of a high-voltage device, it is impossible to arbitrarily set the distance d1 between the inclined portions of the probes 101 and the semiconductor device 5 as the object to be measured, which induces the problem of difficulty of suppressing aerial discharge. On the other hand, as illustrated in FIG. 3B, in the case of the spring type having a spring member 17, due to the principle thereof, it is not necessary to incline the probes 10. Therefore, in evaluating electric characteristics of a high-voltage device, it is possible to arbitrarily set the distance d2 between the semiconductor device 5 and the insulation plate 16 to which the probes 10 are connected, which provides the merit of suppressing aerial discharge as required.

Next, with reference to FIGS. 4 and 5, the spring-type temperature detecting probe 7 will be described. FIG. 4 is a schematic view of the temperature detecting probe 7, and FIG. 5 is a schematic cross-sectional view of a portion of the plunger portion 12. Here, there is illustrated an example of the temperature detecting probe 7 having a thermocouple 19 as a temperature-measuring portion, which is installed inside the tip-end portion of the plunger portion 12 constituting the probe 7.

In evaluating the semiconductor device 5, as illustrated in FIGS. 2A to 2C, the spring-type evaluation probes 10 are brought into contact with the connection pads 18 provided on the upper surface of the semiconductor device 5, which is for the sake of establishing electric conduction between the evaluation probes 10 and the connection pads 18. By employing the spring-type temperature detecting probe 7 intended for temperature detection, which is used together with the probes 10 used for electric conduction, it is possible to easily and accurately determine the temperature of the semiconductor device 5 during evaluations.

As illustrated in FIG. 4, the spring-type temperature detecting probe 7 includes a plunger portion 12, a barrel portion 14, a spring member 17, and a terminal portion 15, similarly to the structure of the evaluation probes 10. The temperature detecting probe 7 further includes a temperature measuring portion, in addition to these structures.

The plunger portion 12 is provided, at its tip end portion, with a contact portion 11 which can come into contact with the semiconductor device 5, and the plunger portion 12 is provided, at its base-end portion, with a cylindrical-shaped pushing portion 13 which is thinner than the tip end portion, wherein the spring member 17 is fitted to the pushing portion 13. The barrel portion 14 is formed to have a cylindrical shape and is structured such that a portion of the pushing portion 13 can be inserted therein. The plunger portion 12, which comes into contact with the semiconductor device 5 at the contact portion 11, is a movable portion, and the barrel portion 14 presses the plunger portion 12 the semiconductor device 5 side with the spring member 17 interposed therebetween. Further, the pushing portion 13 is partially pushed therein in the vertical direction (in +Z direction) through the spring member 17, thereby ensuring the contact thereof with the semiconductor device 5.

The plunger portion 12, in cases where it is for evaluations, is formed from a metal material having electrical conductivity, such as copper, tungsten, rhenium tungsten, for example, but the material thereof is not limited thereto and, particularly, the contact portion 11 adapted to come into contact with the semiconductor device 5 can be formed from a material constituted by the aforementioned metal material coated with another material such as gold, palladium, tantalum, platinum and the like, in view of improvement of the electrical conductivity, improvement of durability, and the like. In this case, there is no need for electrical conductivity for temperature detection, and it is possible to use materials with thermal conductivity, as well as metal materials, provided that the evaluation probes are not appropriated thereas. A resin filled with a filler having enhanced thermal conductivity can apply thereto.

The spring member 17 is a necessary member for easily moving the plunger portion 12 and, in this case, the spring member 17 is provided outside. This is because, as will be described later, the plunger portion 12 is provided inside with a hollow portion, and wirings extended from the temperature measuring portion are passed through the hollow portion, which restricts the usable volume in the space inside the plunger portion 12.

However, in cases where the probe is intended for larger electric currents, the plunger portion 12 itself may have a larger outer diameter and, thus, may have a leeway for providing the spring member 17 in the inside space therein. Thus, the placement of the spring member 17 is not limited to the outside thereof. The barrel portion 14 is a part which forms a base pedestal of the spring-type temperature detecting probe 7 and is used for fixing it to the insulation plate 16. The terminal portion 15 is used as a wiring connection portion for outputting to the control portion 4 and is electrically connected to the pushing portion 13 in the plunger portion 12, and both the portions can be integrated with each other.

In cases where the plunger portion 12 is formed from a material having electrical conductivity, it is necessary to provide a protection portion 20 made of an insulating material, on the contact portion 11 in the plunger portion 12. This is for the following reason. When the spring-type temperature detecting probe 7 is placed together with the conventional evaluation probes 10, at the same position, on the insulation plate 16, they are brought into contact with the connection pads 18 on the surface of the semiconductor device 5, which are for establishing electric conduction to the semiconductor device 5. At this time, it is necessary to avoid conduction of electricity for evaluating the semiconductor device 5, to the spring-type temperature detecting probe 7. However, in cases where the contact portion 11 of the plunger portion 12 is brought into contact with an insulating film, rather than with the connection pad 18 on the semiconductor device 5, there is no need for providing the protection portion 20. Further, the protection portion 20 is desirably formed from a material with a smaller thickness which does not inhibit heat conduction, such as Teflon (trademark), but the material thereof is not limited thereto.

Next, there will be described the temperature measuring portion included in the temperature detecting probe 7. As illustrated in FIG. 5, the tip end portion of the plunger portion 12 is formed to have a cylindrical shape and has an outer diameter of about 5 mm to about 10 mm, in general, depending on the electric current applied thereto, in cases where the temperature detecting probe 7 is intended for evaluations. The temperature measuring portion is constituted by a thermocouple 19. In the temperature detecting probe 7, the thermocouple 19 is placed inside the plunger portion 12. For coping therewith, the plunger portion 12 interiorly includes a hollow portion 21 with an inner diameter of at least about 3 mm, and, therefore, the plunger portion 12 has an outer diameter of 6 mm or more. In cases where the plunger portion 12 is formed from a metal, the hollow portion 21 is formed by hollowing it out through cutting processing.

The thermocouple 19 is placed inside the tip end portion of the plunger portion 12. The thermocouple 19 is constituted by two different types of metals which are connected to each other and is adapted to detect the temperature from the electromotive force induced by the temperature difference between both the contact points, wherein the metal materials selected therein are copper/constantan, chromel/alumel, and the like, but are not limited thereto. The thermocouple 19 can be fabricated to have an outer diameter of about 1 mm for detecting temperatures at fine portions. The thermocouple 19 includes a wiring 22 having one end side which extends from the upper end of the terminal portion 15 and is connected to the control portion 4. In this example, the thermocouple 19 is placed inside the plunger portion 12 such that it is isolated from the outside, which ensures the protection of the thermocouple 19 from the external environment. Further, the protection portion 20 covers a portion of the thermocouple 19 with the plunger portion 12 interposed therebetween, thereby protecting the thermocouple 19.

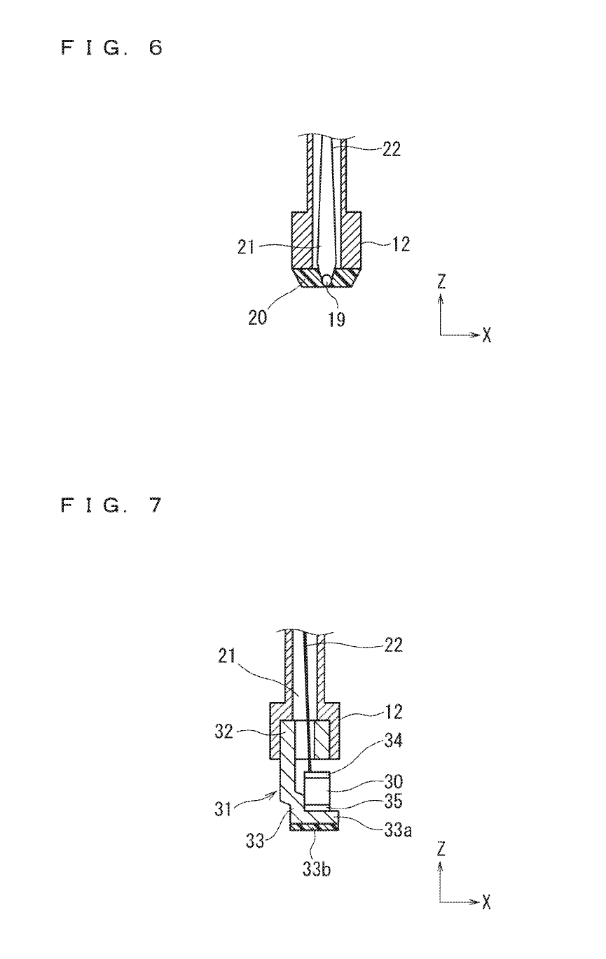

Next, modification examples of the temperature detecting probe 7 will be described. FIG. 6 is a schematic cross-sectional view of a portion of the plunger portion 12 of the temperature detecting probe 7 according to a modification example 1 of the preferred embodiment. The present modification example 1 is the same as that in FIG. 5 except that the thermocouple 19 is placed outside the tip end portion of the plunger portion 12 and, therefore, will not be described redundantly. As illustrated in FIG. 6, the hollow portion 21 is provided in a state of penetrating the tip end portion of the plunger portion 12, and the tip end portion of the thermocouple 19 is placed in a state of protruding from the tip end of the plunger portion 12. In order to prevent the thermocouple 19 from directly coming into contact with the semiconductor device 5, the thermocouple 19 is covered with the protection portion 20. The protection portion 20 is formed from a resin filled with a filler having enhanced heat conductivity, for example, but is not limited thereto. In the present modification example 1, the temperature measuring portion can be placed further closer to the semiconductor device 5, which can improve the accuracy of the detection of the temperature of the semiconductor device 5.

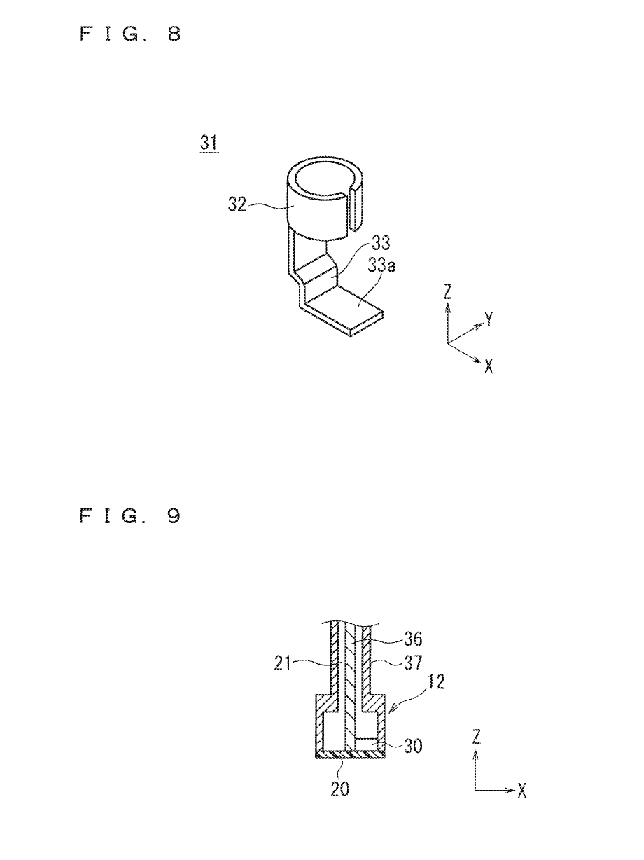

FIG. 7 is a schematic cross-sectional view of a portion of the plunger portion 12 of the temperature detecting probe 7 in a modification example 2 of the preferred embodiment, and FIG. 8 is a schematic perspective view of a temperature-measuring-portion installation jig 31. As illustrated in FIG. 7, the temperature measuring portion is constituted by a surface-mounting type thermistor 30, and the temperature-measuring-portion installation jig 31 having the thermistor 30 installed therein is placed by being fitted to the tip end portion of the plunger portion 12. The other structures are the same as those in the aforementioned example and will not be described.

The thermistor 30 is one type of a temperature measuring resistor member and is adapted to detect the temperature using electric resistance changes in an oxide. There are thermistors having various configurations, such as those including lead wires. In this case, a surface-mounting type element is selected thereas in view of size reduction, but the thermistor is not limited thereto. Such a surface-mounting type thermistor has an outer diameter of about 1 mm, at its longer sides. The temperature-measuring-portion installation jig 31 for installing the thermistor 30 therein is formed from a metal material having electrical conductivity, such as copper, and is fabricated through sheet metal working, but the temperature-measuring-portion installation jig 31 is not limited thereto.

The temperature-measuring-portion installation jig 31 includes a fitting portion 32 having a substantially-tubular shape, and a main body portion 33 having a substantially-L shape in a side plan view. The main body portion 33 has a bottom portion which forms a temperature-measuring-portion installation portion 33a, and the thermistor 30 is installed on the upper surface of the temperature-measuring-portion installation portion 33a. Namely, the temperature-measuring-portion installation portion 33a is interposed between the thermistor 30 and the semiconductor device 5 and, thus, has the function of protecting the thermistor 30. Further, the temperature-measuring-portion installation portion 33a is formed from a plate material having heat conductivity and, therefore, has the function of efficiently transferring heat from the semiconductor device 5 to the thermistor 30.

As illustrated in FIG. 7, the surface-mounting type thermistor 30 is provided with electrodes 34 and 35, at its upper and lower end portions. The electrode 35 is electrically and mechanically connected to the temperature-measuring-portion installation portion 33a, through soldering and the like. A wiring 22 is connected to the electrode 34. The wiring 22 extends, at its one end side, from the upper end of the terminal portion 15. The electrode 35 is connected to the plunger portion 12 with the temperature-measuring-portion installation jig 31 interposed therebetween and, further, is connected to the terminal portion 15.

The hollow portion 21 is formed to have two stages. Namely, the portion of the hollow portion 21 which is coincident with the tip end portion of the plunger portion 12 is formed to have a through shape and, further, is formed to have a larger inner diameter than that of the other portion. The tip end portion of the plunger portion 12 is fitted to the fitting portion 32 and is electrically and mechanically connected to the temperature-measuring-portion installation jig 31. The temperature-measuring-portion installation jig 31 is formed from a material with electrical conductivity and, therefore, an insulating portion 33b formed from an insulating material is further placed at the position where the temperature-measuring-portion installation portion 33a comes into contact with the semiconductor device 5 (on the lower surface of the temperature-measuring-portion installation portion 33a). In this case, the temperature-measuring-portion installation portion 33a corresponds to a protection portion for protecting the thermistor 30 as the temperature measuring portion.

This enables placing the temperature measuring portion further closer to the semiconductor device 5, which can improve the accuracy of the detection of the temperature of the semiconductor device 5. Further, in the event of failures of the thermistor 30 as the temperature measuring portion, it is possible to easily perform replacement thereof.

Further, although there has been described an example where the thermistor 30 is used as the temperature measuring portion, the temperature measuring portion is not limited to the thermistor 30 and can be also constituted by a platinum resistor member. Such a platinum resistor member is for detecting the temperature by utilizing the fact that the electric resistance of a metal changes substantially proportionally to the temperature.

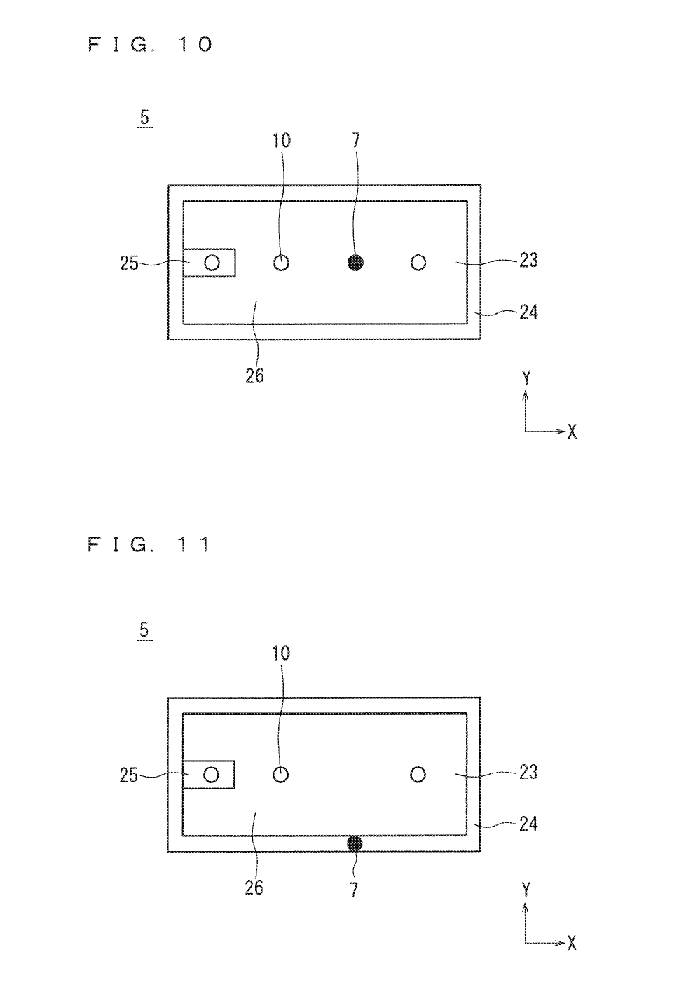

FIG. 9 illustrates a yet another modification example where the temperature measuring portion is provided inside the plunger portion 12. FIG. 9 is a schematic cross-sectional view of a portion of the plunger portion 12 of the temperature detecting probe 7 according to a third modification example of the preferred embodiment. As illustrated in FIG. 9, a coaxial-type two-shaft contact probe is applied thereto, and the surface-mounting type thermistor 30 forming the temperature measuring portion is placed between the two shafts.

The plunger portion 12 is constituted by a second electrode shaft 37, and a first electrode shaft 36 placed inside the second electrode shaft 37. In the coaxial-type two-shaft contact probe, the first electrode shaft 36 and the second electrode shaft 37 are insulated from each other and generate respective outputs. The first electrode shaft 36 and the second electrode shaft 37 are connected to an output electrode of the thermistor 30, which enables acquiring the output from the thermistor 30 through wiring connection portions which are extended portions of the respective electrode shafts 36 and 37. Further, in order to ensure the insulation between the thermistor 30 and the respective electrode shafts 36 and 37 and the semiconductor device 5, there is placed the protection portion 20 formed from a material with an insulating property, on the portion of the plunger portion 12 which comes into contact with the semiconductor device 5.

Further, although there has been described an example where the thermistor 30 is used as the temperature measuring portion, the temperature measuring portion is not limited to the thermistor 30 and can be also constituted by a platinum resistor member.

This enables installing the temperature measuring portion without interposing a wiring portion, which makes it easier to perform replacement of the temperature measuring portion, at the time of the installation, and in the event of failures thereof.

Further, the temperature detecting probe 7 is intended for detecting the temperature of the semiconductor device 5 during evaluations of electric characteristics thereof, but is not limited thereto and can be also used for simply detecting the temperature of a jig or the temperature of a device being processed, by being brought into contact therewith.

Next, there will be described an example of placement of the spring-type temperature detecting probe 7 placed on the insulation plate 16. FIG. 10 is a schematic view illustrating an example of the placement and structure of the temperature detecting probe 7 and, more specifically, a plan view illustrating a single semiconductor device 5, the evaluation probes 10 and the temperature detecting probe 7 during an evaluation. Further, for simplifying the drawing, the insulation plate 16 is not illustrated therein, and a black round mark indicates the position with which the temperature detecting probe 7 comes into contact, and white round marks indicate the positions with which the evaluation probes 10 come into contact.

The semiconductor device 5 is a high-withstand-voltage semiconductor device for use in electric-power conversion devices and the like, particularly, and is an IGBT, an MOSFET, a diode or the like, for example. The semiconductor device 5 which exhibits such a higher withstand voltage includes an active area 23 for controlling the electric current, and a termination area 24 adapted to have an isolation withstand voltage. The active area 23 is provided at a center portion of the semiconductor device 5, and the termination area 24 is provided at a peripheral edge portion of the semiconductor device 5. The semiconductor device 5, which will be described by exemplifying an IGBT hereinafter, has a gate electrode 25 and an emitter electrode 26 as connection pads used for connection to the outside, which are provided in the active area 23. The temperature detecting probe 7 comes into contact with a center portion of the emitter electrode 26 in the semiconductor device 5, thereby detecting the temperature at this position. Namely, the temperature at the center portion of the emitter electrode 26 in the semiconductor device 5 is treated as a representative value of the temperature of the surface of the active area 23 in the semiconductor device 5.

Here, it can be conceived that a heater is placed in such a way as to surround an object to be measured, and a temperature detecting probe placed inside the heater is positioned at a center portion of this surrounded shape. However, in this case, the center portion is specified as an area which is most unsusceptible to the heating effect of the heater, and this case is different from the present preferred embodiment in terms of the structure and the effect.

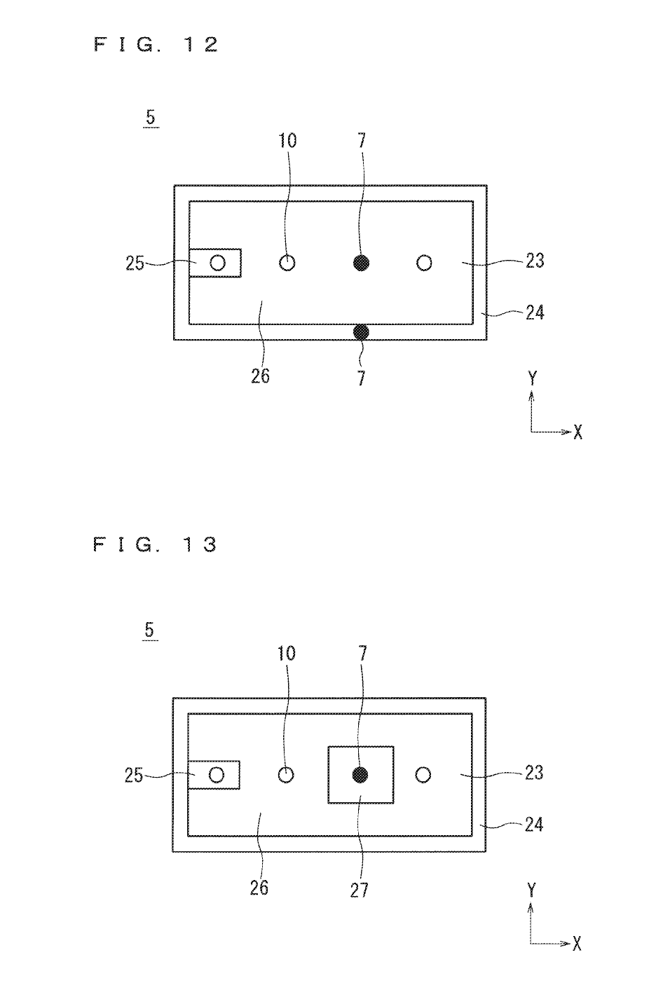

Next, there will be described other examples of the placement and structure of the temperature detecting probe 7. FIGS. 11, 12 and 13 are schematic views illustrating the other examples of the placement and structure of the temperature detecting probe 7.

The placement of the temperature detecting probe 7 is not limited to that of FIG. 10, and the temperature detecting probe 7 can be also placed in the termination area 24 of the semiconductor device 5 for detecting the temperature at the termination area 24, as illustrated in FIG. 11. This is for the following reason. It is known that, in detecting temperature changes along with the phenomenon of destruction of the semiconductor device 5 during evaluations, particularly, partial discharge can occur in the termination area 24, as well as in the active area 23 in the semiconductor device 5.

Further, as illustrated in FIG. 12, the temperature detecting probe 7 can be also placed in each of the active area 23 as a center area and the termination area 24, in order to detect temperatures at the active area 23 and at the termination area 24. By detecting the temperature of the surface of the semiconductor device 5 at two or more positions, it is possible to evaluate the uniformity of the temperature of the semiconductor device 5, thereby improving the accuracy of the detection of destruction phenomena and partial discharge.

Further, as illustrated in FIG. 13, the temperature detecting probe 7 can be also adapted to be brought into contact with an insulation layer 27 placed on the emitter electrode 26. By bringing it into contact with the insulation layer 27, it is possible to eliminate the necessity of the protection portion 20. The insulation layer 27 can be placed by forming it during the process for placing an insulation layer on the termination area 24, for example, and there is no need for particularly providing an additional process.

Next, there will be described a procedure for operating the semiconductor device evaluation apparatus 1 according to the preferred embodiment. In cases where the semiconductor device evaluation apparatus 1 includes two or more evaluation probes 10, the contact portions 11 of the evaluation probes 10 are aligned with each other in terms of parallelism, before evaluations of electric characteristics of the semiconductor device 5. The temperature detecting probe 7 is placed such that the tip end portion of the temperature detecting probe 7 is positioned below the tip end portions of the evaluation probes 10, in the state before evaluations of electric characteristics of the semiconductor device 5, more accurately, before the probes are brought into contact with the semiconductor device 5, in order to enable bringing the temperature detecting probe 7 into contact with the surface of the semiconductor device 5, beforehand. The semiconductor device 5 is placed on the chuck stage 3, such that the installation surface of the semiconductor device 5 comes in contact with the chuck stage 3. The semiconductor device 5 may be a semiconductor wafer having plural semiconductor chips formed thereon or be such semiconductor chips themselves, for example, but is not limited thereto and can be any semiconductor devices which can be fixed through vacuum suction and the like.

After the semiconductor device 5 has been fixed to the chuck stage 3, at first, the control portion 4 brings the temperature detecting probe 7 into contact with the surface of the semiconductor device 5 to detect the temperature of the surface of the semiconductor device 5 and, further, checks whether or not it is a desired evaluation temperature. If it has reached the desired evaluation temperature, the control portion 4 brings the evaluation probes 10 into contact with the connection pads 18. Thereafter, the control portion 4 performs evaluations of desired electric characteristics and, at the same time, the control portion 4 continues detecting the temperature of the surface of the semiconductor device 5. This is for accurately detecting the temperature of the semiconductor device 5 during the evaluations and for grasping temperature rises due to heat generation during conduction of electricity thereto and cooling subsequent thereto. In this case, the control portion 4 corresponds to an evaluation portion adapted to evaluate electric characteristics of the semiconductor device 5 through the evaluation probes 10.

Further, if the detected temperature exceeds a pre-set value, namely the control portion 4 determines that abnormal heat generation, a destruction phenomenon, partial discharge or like has occurred, the control portion 4 ceases the evaluations of electric characteristics of the semiconductor device 5 and stores the position of the semiconductor device 5 having been subjected to the evaluations, even halfway through the evaluations of electric characteristics. This is for removing the semiconductor device 5 having induced such partial discharge therein, from the subsequent processes.

Next, there will be described effects of the temperature detecting probe 7, the semiconductor device evaluation apparatus 1 and the semiconductor device evaluating method according to the preferred embodiment.

In the temperature detecting probe 7 according to the preferred embodiment, the plunger portion 12 is pressed the semiconductor device 5 side by the barrel portion 14 with the spring member 17 interposed therebetween, which ensures the contact between the plunger portion 12 and the semiconductor device 5, and the temperature of the semiconductor device 5 is detected by the temperature measuring portion. This enables accurately detecting the temperature of the semiconductor device 5, before evaluations of electric characteristics of the semiconductor device 5.

Further, since the temperature detecting probe 7 is adapted such that the plunger portion 12 is pressed the semiconductor device 5 side through the spring member 17, it is possible to provide a larger distance from the semiconductor device 5 to the insulation plate 16 to which the temperature detecting probe 7 is connected, which can suppress aerial discharge, in comparison with cases of cantilever types.

The temperature measuring portion is placed inside the tip end portion of the plunger portion 12, which can enhance the protection of the temperature measuring portion from the external environment.

The protection portion 20 is placed on the portion of the plunger portion 12 which comes into contact with the semiconductor device 5, which can protect the temperature measuring portion. This enables elongating the life of the temperature measuring portion.

The protection portion 20 includes an insulating material having heat conductivity which covers at least a portion of the temperature measuring portion, which can easily protect the temperature measuring portion, without degrading the accuracy of the detection of the temperature of the semiconductor device 5.

The temperature measuring portion includes the thermocouple 19, which enables easily reducing the size of the temperature detecting probe 7 and, also, enables easily installing it inside the plunger portion 12. This enables improvement of the yield of the temperature detecting probe 7.

In the modification example 1 of the preferred embodiment, as illustrated in FIG. 6, the temperature measuring portion is placed outside the tip end portion of the plunger portion 12, which enables putting the temperature measuring portion closer to the semiconductor device 5, thereby improving the accuracy of the detection of the temperature of the semiconductor device 5.

In the modification example 2 of the preferred embodiment, as illustrated in FIG. 7, the temperature-measuring-portion installation portion 33a as the protection portion includes a plate member having heat conductivity which is interposed between the temperature measuring portion and the semiconductor device 5. This can easily protect the temperature measuring portion without degrading the accuracy of the detection of the temperature of the semiconductor device 5.

In the modification example 3 of the preferred embodiment, as illustrated in FIG. 9, the temperature measuring portion is placed between the first electrode shaft 36 and the second electrode shaft 37 which is included in the plunger portion 12, and the protection portion 20 is placed on the portion of the plunger 12 which comes into contact with the semiconductor device 5. This makes it easier to perform installation and replacement of the temperature measuring portion.

In the modification examples 2 and 3 of the preferred embodiment, when the temperature measuring portion includes a platinum resistor member or the thermistor 30, as illustrated in FIGS. 7 and 9, a surface-mounting type resistor member can be employed thereas, which can easily reduce the size of the temperature detecting probe 7.

The semiconductor device evaluation apparatus 1 according to the preferred embodiment includes the temperature detecting probe 7, the chuck stage 3 for fixing the semiconductor device 5 thereto, the spring-type evaluation probes 10, and the control portion 4 adapted to evaluate electric characteristics of the semiconductor device 5 through the evaluation probes 10. Accordingly, in evaluating electric characteristics of the semiconductor device 5, it is possible to accurately detect the temperature of the semiconductor device 5.

Further, the temperature detecting probe 7 is adapted to press the plunger portion 12 toward the semiconductor device 5 through the spring member 17, which can provide a larger distance from the semiconductor device 5 to the insulation plate 16 to which the temperature detecting probe 7 is connected, thereby suppressing aerial discharge, in comparison with cases of cantilever types.

It is possible to simply detect occurrences of partial discharges, from temperature rises induced in the semiconductor device 5 during evaluations of electric characteristics of the semiconductor device 5. By immediately ceasing the evaluations after the detection of the occurrence of a partial discharge, it is possible to suppress failures of the evaluation probes 10, the temperature detecting probe 7, the connection pads and the like. Further, it is possible to identify the semiconductor device 5 which has induced a partial discharge therein during evaluations, and it is possible to remove this semiconductor device 5 from the subsequent processes. This can eliminate the necessity of checking for the occurrence of partial discharges after the evaluations, which enables shortening the processes.

The tip end portion of the temperature detecting probe 7 is positioned below the tip end portions of the evaluation probes 10, in the state before evaluations of electric characteristics of the semiconductor device 5, which enables bringing only the temperature detecting probe 7 into contact with the semiconductor device 5 beforehand. By performing evaluations of electric characteristics of the semiconductor device 5 after checking the temperature of the surface of the semiconductor device 5, it is possible to suppress changes of the temperature of the semiconductor device 5 due to the contact of the plural probes therewith.

As illustrated in FIG. 10, the temperature detecting probe 7 is placed such that it can come into contact with the center portion of the emitter electrode 26 which is the active area 23 in the semiconductor device 5. This enables detecting the temperature of the active area 23 in the semiconductor device 5. Assuming that this temperature is the temperature of the semiconductor device 5 during evaluations of electric characteristics thereof, this temperature is treated as a representative value of the temperature of the semiconductor device 5, which can reduce, in number, the temperature detecting probe 7 placed therein, thereby reducing the cost.

As illustrated in FIG. 11, the temperature detecting probe 7 is placed such that it can come into contact with the termination area 24 which is the peripheral edge portion of the semiconductor device 5. This enables detecting destruction phenomena such as discharges, which frequently occur in the termination area 24 of the semiconductor device 5.

As illustrated in FIG. 12, the temperature detecting probe 7 is placed such that it can come into contact with the active area 23 and the termination area 24 in the semiconductor device 5, which enables detecting the temperatures at the active area 23 and the termination area 24. This enables detecting the temperature of the surface of the semiconductor device 5 without unevenness. This also enables detecting temperature abnormality in the event of partial destructions in the semiconductor device 5.

Further, in the present preferred embodiment, the evaluation probes 10 and the temperature detecting probe 7 are placed on the same insulation plate 16, but the present invention is not limited thereto, and they may be placed on respective different insulation plates. In this case, the respective probes 7 and 10 can be brought into contact or un-contact with the semiconductor device 5 independently of each other, which enables adjusting the amount of pressing of them against the semiconductor device 5 independently of each other, thereby suppressing excessive loads exerted on the semiconductor device 5. This can suppress failures of the semiconductor device 5.

The control portion 4 controls evaluations of electric characteristics of the semiconductor device 5 by the evaluation probes 10 and the evaluation portion, based on the temperature of the semiconductor device 5 which has been detected by the temperature detecting probe 7. Therefore, after detecting abnormality of the temperature of the semiconductor device 5, the control portion 4 can cease the evaluations, even before the completion of the evaluations. This can suppress failures of the evaluation probes 10, the temperature detecting probe 7, the connection pads and the like.

The semiconductor device evaluating method according to the preferred embodiment includes a process (a) for evaluating electric characteristics of the semiconductor device 5 using the evaluation probes 10 and the control portion 4, and a process (b) for detecting the temperature of the surface of the semiconductor device 5 before the evaluation in the process (a) and during the evaluation in the process (a), using the temperature detecting probe 7. This enables simply and accurately detecting the temperature of the surface of the semiconductor device 5. Further, it is possible to suppress aerial discharge, similarly in the aforementioned description.

The semiconductor device evaluating method further includes a process (c) for ceasing the evaluation of electric characteristics of the semiconductor device 5 in the process (a), based on the temperature of the surface of the semiconductor device 5 which has been detected in the process (b). This enables ceasing the evaluation, even before the completion of the evaluation, after the detection of abnormality of the temperature of the semiconductor device 5. This can suppress failures of the evaluation probes 10, the temperature detecting probe 7, the connection pads and the like.

Further, in the present invention, it is possible to make modifications and eliminations to the preferred embodiment, within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A contact-probe type temperature detector comprising:
a plunger portion contactable with an object to be measured;
a spring member placed on a base end portion of said plunger portion;
a barrel portion pressing said plunger portion said object to be measured side with said spring member interposed therebetween; and
a temperature measuring portion detecting a temperature of said object to be measured.

2. The contact-probe type temperature detector according to claim 1, wherein
said temperature measuring portion is placed inside a tip end portion of said plunger portion.

3. The contact-probe type temperature detector according to claim 1, wherein
said temperature measuring portion is placed outside a tip end portion of said plunger portion.

4. The contact-probe type temperature detector according to claim 3, wherein
a protection portion is placed on a portion of said plunger portion which comes into contact with said object to be measured.

5. The contact-probe type temperature detector according to claim 4, wherein
said protection portion includes an insulation material having heat conductivity which covers at least a portion of said temperature measuring portion.

6. The contact-probe type temperature detector according to claim 4, wherein
said protection portion includes a plate member having heat conductivity which is interposed between said temperature measuring portion and said object to be measured.

7. The contact-probe type temperature detector according to claim 2, wherein
said temperature measuring portion is placed between a first electrode shaft and a second electrode shaft which is included in said plunger portion, and
a protection portion is placed on a portion of said plunger portion which comes into contact with said object to be measured.

8. The contact-probe type temperature detector according to claim 1, wherein
said temperature measuring portion includes a thermocouple.

9. The contact-probe type temperature detector according to claim 1, wherein
said temperature measuring portion includes a platinum resistor member or a thermistor.

10. A semiconductor device evaluation apparatus comprising:
the contact-probe type temperature detector according to claim 1;
a stage for fixing said object to be measured thereto;
a spring-type evaluation probe; and
an evaluation portion evaluating an electric characteristic of said object to be measured, through said evaluation probe.

11. The semiconductor device evaluation apparatus according to claim 10, wherein
a tip end portion of said contact-probe type temperature detector is positioned below a tip end portion of said evaluation probe, in a state before an evaluation of the electric characteristic of said object to be measured.

12. The semiconductor device evaluation apparatus according to claim 10, wherein
said contact-probe type temperature detector is placed in such a way as to be contactable with a center portion of said object to be measured.

13. The semiconductor device evaluation apparatus according to claim 10, wherein
said contact-probe type temperature detector is placed in such a way as to be contactable with a peripheral edge portion of said object to be measured.

14. The semiconductor device evaluation apparatus according to claim 10, wherein
said contact-probe type temperature detector is placed in such a way as to be contactable with a center portion and a peripheral edge portion of said object to be measured.

15. The semiconductor device evaluation apparatus according to claim 10, wherein
said evaluation probe and said contact-probe type temperature detector are placed on respective different insulation plates.

16. The semiconductor device evaluation apparatus according to claim 10, further comprising
a processing circuit controlling the evaluation of the electric characteristic of said object to be measured by said evaluation probe and said evaluation portion, based on the temperature of said object to be measured which is detected by said contact-probe type temperature detector.

17. A semiconductor device evaluating method using a semiconductor device evaluation apparatus,
said semiconductor device evaluation apparatus comprising:
a contact-probe type temperature detector including,
a plunger portion contactable with an object to be measured,
a spring member placed on a base end portion of said plunger portion,
a barrel portion pressing said plunger portion said object to be measured side with said spring member interposed therebetween, and
a temperature measuring portion detecting a temperature of said object to be measured;
a stage for fixing said object to be measured thereto;
a spring-type evaluation probe; and
an evaluation portion evaluating an electric characteristic of said object to be measured, through said evaluation probe,
said semiconductor device evaluating method comprising:
(a) evaluating an electric characteristic of said object to be measured using said evaluation probe and said evaluation portion; and
(b) detecting a temperature of a surface of said object to be measured before the evaluation in said (a) and during the evaluation in said (a), using said contact-probe type temperature detector.

18. The semiconductor device evaluating method according to claim 17, further comprising
(c) ceasing the evaluation of the electric characteristic of said object to be measured in said (a), based on the temperature of the surface of said object to be measured which has been detected in said (b).
